(19) United States
(12) Patent Application Publication
(10) Pub. No.: US 2018/0108021 A1
(43) Pub. Date: Apr. 19, 2018

(54) Attendance System

(71) Applicant: Palace Sports & Entertainment, Inc., Auburn Hills, MI (US)

(72) Inventor: Christopher Pittenturf, Oakland Township, MI (US)

(73) Assignee: Palace Sports & Entertainment, Inc., Auburn Hills, MI (US)

(21) Appl. No.: 15/785,352

(22) Filed: Oct. 16, 2017

Related U.S. Application Data
(60) Provisional application No. 62/408,362, filed on Oct. 14, 2016.

(51) Int. Cl. G06Q 30/00; G06Q 10/02

(52) U.S. Cl. CPC G06Q 30/01; G06Q 10/02

(57) ABSTRACT

An attendance system includes a central computer system in communication with a ticket management computer system and a customer management computer system. The attendance system additionally includes a plurality of mobile electronic devices in communication with the central computer system. The central computer system stores ticket information pertaining to tickets of one or more customers, which is received from the ticket management computer system. The ticket information includes location assignment information and usage information for respective tickets. Respective mobile electronic devices receive the ticket information from the central computer system, and display the ticket information in a consolidated manner.

### CROSS-REFERENCE TO RELATED APPLICATION(S)

This disclosure claims the benefit of U.S. Provisional Application No. 62/408,362, filed Oct. 14, 2016, the disclosure of which is hereby incorporated by reference in its entirety.

### TECHNICAL FIELD

This disclosure relates to event ticketing and, in particular, ticketing systems for event venues.

### SUMMARY

In an implementation, a system is provided for real-time distribution of electronic records generated based on data received from a plurality of sources. The system comprises a centralized computing device including a memory and a processor. The plurality of sources are external to the centralized computing device. The processor is configured to execute instructions stored in the memory to receive first data from a first source of the plurality of sources. The first data reflects that a ticket holder is admitted access to a venue. The processor is further configured to execute instructions stored in the memory to receive second data from a second source of the plurality of sources. The second data includes information associated with the ticket holder. The processor is further configured to execute instructions stored in the memory to generate an electronic record in real-time upon receipt of the first data and the second data. The electronic record indicates the first data and the second data. The processor is further configured to execute instructions stored in the memory to distribute the electronic record to a plurality of mobile electronic devices in real-time upon generation of the electronic record. The plurality of mobile electronic devices is located at the venue.

In another implementation, a method is provided for real-time distribution of electronic records generated based on data received from a plurality of external sources. The method comprises receiving first data from a first external source of the plurality of external sources. The first data reflects that a ticket holder is admitted access to a venue. The method further comprises receiving second data from a second external source of the plurality of external sources. The second data including information associated with the ticket holder. The method further comprises generating an electronic record in real-time upon receipt of the first data and the second data. The electronic record indicates the first data and the second data. The method further comprises distributing the electronic record to a plurality of mobile electronic devices in real-time upon generation of the electronic record. The plurality of mobile electronic devices is located at the venue.

In another implementation, a non-transitory computer-readable storage medium is provided. The non-transitory computer-readable storage medium comprises processor-executable routines that, when executed by a processor, facilitate a performance of operations. The operations comprise generating an electronic record in real-time upon receipt of first data and second data. The first data is received from a computing device associated with a ticket management computer system and includes a ticket identifier associated with a ticket used to admit access to a venue for a ticket holder. The second data is received from a computing device associated with a customer management computer system and includes an account identifier associated with the ticket holder. The operations further comprise distributing the electronic record to a plurality of mobile electronic devices in real-time upon generation of the electronic record, the plurality of mobile electronic devices located at the venue. The distributing causes the plurality of mobile electronic devices to display the record. The distributing further causes a value of a binary indicator to change in order to reflect that the ticket has been used to admit access to the venue for the ticket holder.

These and other aspects of this disclosure are disclosed in the following detailed description of the implementations, the appended claims and the accompanying figures.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a system schematic of an exemplary embodiment of an attendance system.

FIG. 2 is a flow chart of a method implemented by the attendance system of FIG. 1.

FIG. 3 is a flow chart of substeps of a step of the method shown in FIG. 2.

FIG. 4 is a flow chart of substeps of an alternative step of the method shown in FIG. 2.

FIG. 5 is a flow chart of substeps of another step of the method shown in FIG. 2.

FIG. 6 is a flow chart of substeps of another alternative step of the method shown in FIG. 2.

FIG. 7 is a flow chart of another method that may be implemented in conjunction with the method shown in FIG. 2.

FIG. 8 is a plan view of a mobile electronic device displaying a first graphical user interface.

FIG. 9 is another plan view of the mobile electronic device shown in FIG. 8 displaying a second graphical user interface.

### DETAILED DESCRIPTION

Ticketing systems provide ticket inventory management and event access management. Customer relationship management systems store various information pertaining to customers, and are useful to salespersons of tickets (e.g., for season ticket sales). However, ticketing systems and customer relationship management systems, which are provided as discrete systems, store and provide information separately for any one customer. The information discretely processed by those systems must be separately transmitted to a different system used by a person or entity operating an event venue. However, because that information is separately transmitted, the person or entity operating the event venue may be delayed in using both sets of information, for example, to determine customer attendance at the venue. Furthermore, the separate transmission of that information may require the person or entity operating the event venue to combine the separately transmitted information before they or it can identify meaningful information about customers and their used or unused tickets. Implementations of an attendance system as disclosed herein solve problems such as those by generating, consolidating, and associating real-time ticket information (e.g., real-time ticket usage) with customer information. That real-time ticket information is then distributed in real-time to a plurality of mobile electronic devices used by employees or other representatives of an event venue. The real-time data exchange implemented using the attendance systems disclosed herein allows an operator of an event venue to have real-time information about customer attendance, ticket usage, or the like. The implementations of the attendance system as disclosed herein thereby enable salespersons to more easily monitor attendance identify and interact with customers during events held at a venue. As used herein, a customer refers to a ticket holder of one or more tickets used to admit a person to access a venue. The customer may therefore be a purchaser or otherwise an acquirer of such a ticket.

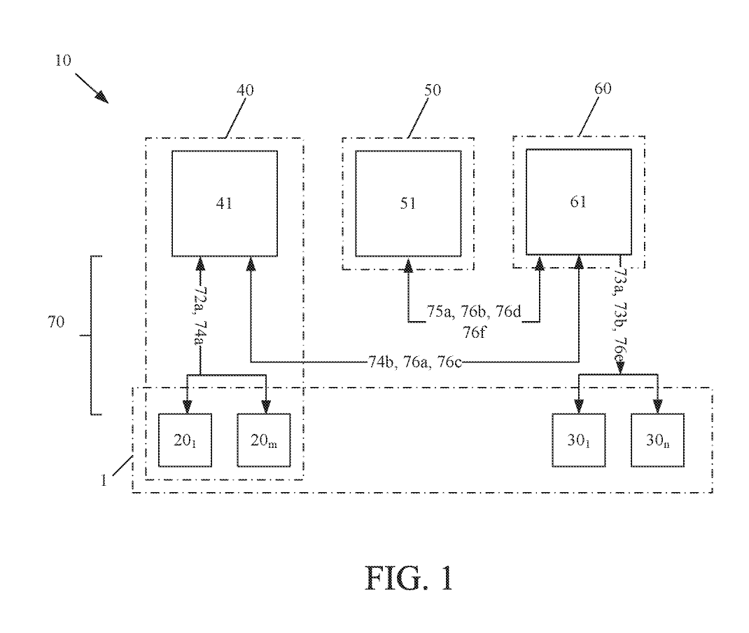

Referring first to FIG. 1, an attendance system 10 (e.g., ticketing system, attendance tracking system, etc.) for an event venue 1 includes ticket scanning devices 20₁₋ₘ and mobile electronic devices 30₁₋ₙ, which are located at the event venue 1 during an event held at the event venue 1, where m is the number or ticket scanning devices 20 and n is the number of mobile electronic devices. The attendance system 10 provides users of the mobile electronics devices 30 real-time alerts and/or statuses about usage of tickets that are associated with ticket customers (e.g., purchaser, acquirer, etc.) that are associated with the user (e.g., customer manager, salesperson, etc.) of one of the mobile electronic devices 30. For example, the attendance system 10 provides respective users via their mobile electronic device 30 alerts and/or statuses of ticket scanning (i.e., usage) at a first macro level by customer (e.g., has any ticket associated with the customer been scanned) and also at a second, more granular level by ticket block associated with the customer (e.g., has any ticket in a ticket block associated with the customer been scanned). By consolidating alerts and/or statuses by user, by customer, and by ticket blocks associated with the customer, in conjunction with simultaneously providing location information of the ticket blocks (e.g., location assignment), the attendance system 10 advantageously enables users to quickly locate customers, or other ticket users possibly associated with the customer, that are present at the venue during an event. This real-time information may be used by the user for customer relationship management, safety or other informative communications, identifying unauthorized ticket usage, etc. The attendance system 10 also overcomes technical challenges of providing different information from multiple, disparate systems or services, to many users spread apart within the venue 1.

The event venue 1 may, for example, be an arena, stadium, theater, etc. having physical bounds and at which occurs an event (e.g., sports game, concert, theater performance, convention, etc.). Respective tickets, when scanned by one of the ticket scanning devices 20, grant permission to the ticketholder to enter the event venue 1. Respective tickets have a location assignment that corresponds to a unique physical location within the physical bounds of the event venue 1 and to which the ticket provides authorized access. The location assignment may, for example, be identified by section, row, and seat within the event venue 1 (e.g., Section 101, Row A, Seat 1). A ticket block is a group of tickets that are associated with a single customer (e.g., by purchase or other acquisition) and that have adjacent location assignments. For example, a ticket block includes tickets of Customer #1 having location assignments in Section 101, Row A, Seats 1-4. Respective tickets may also have additional permissions associated therewith, for example, granting access to a restricted area within the event venue 1 that may include the seat location (e.g., suite level) or may be separate from an area containing the seat location (e.g., privileged club room).

The attendance system 10 additionally includes a ticket management system 40, which may include the ticket scanning devices 20, a customer management system 50, and a central system 60, which are implemented by one or more computer systems (e.g., ticket management, customer management, and central computer systems 41, 51, 61). The computer systems 41, 51, 61 are in communication with the ticket scanning devices 20 and the mobile electronic devices 30 via a network 70. Each of the computer systems 41, 51, 61 includes one or more computing devices. For example, the computer system 41 may include a computing device used by or otherwise associated with the ticket management system 40. In another example, the computer system 51 may include a computing device used by or otherwise associated with the customer management system 50. In yet another example, the computer system 61 may include a centralized computing device used by or otherwise associated with the central system 60.

Broadly speaking, the ticket management system 40 issues available tickets to customers or other recipients (e.g., ticket inventorying function), and also ensures that proper permission(s) are granted when a ticket is scanned by one of the ticket scanning devices 20 (e.g., event access function). When performing the ticket inventorying function, the ticket management system 40 may issue individual tickets or blocks of tickets to customers for a single event or a series of events (e.g., season tickets). Further, when the ticket management system 40 performs the event access function, ticketholders are granted access to the event venue 1 when a valid ticket (e.g., for the current event and not previously scanned) is scanned by the scanning device 20. The customer management system 50 receives, stores, and provides information pertaining to customers associated with the user. The central system 60 gathers and associates information pertaining to the tickets and their customers from the ticket management system 40 and the customer management system 50, as discussed in further detail below.

It should be understood that the ticket management system 40, the customer management system 50, and the central system 60 may be dispersed and/or consolidated in various manners (e.g., to be performed by fewer or more computer systems). For example, the ticket management system 40 may be divided into an event access system and a ticket inventory system, which handle the event access function and the ticket inventorying function, respectively, and which are in communication with each other. Furthermore, the ticket management system 40, the customer management system 50, and the central system 60 may be provided as third party services to an operator of the event venue 1. For example, the ticket scanning devices 20 may be owned leased, or provided as a service, in conjunction with the ticket management system 40.

Respective computer systems 41, 51, 61 are configured with at least one of each of a memory, a processor, and a communication interface, as recognized by those skilled in the art. The memory stores a program (e.g., software module or code) that is executed by the processor, along with various data, while the communication interface allows the computer system to communicate (e.g., via the network 70) with other computer systems. Respective computer systems may, for example, include one or more computer servers. The network 70 may provide for wired and/or wireless via communications protocols and devices, as recognized by those skilled in the art. As will be described below, a centralized computing device of the central computer system 61 may be configured to receive data from a plurality of sources external to that centralized computing device. For example, the sources external to the centralized computing devices from which the centralized computing device receives data may include a computing device associated with the ticket management computer system 41 and a computing device associated with the customer management computer system 51.

The ticket management system 40 issues available tickets to the customers or the other recipients when performing the ticket inventorying function. Ticket management computer system 41 may execute programming and store data in various manners sufficient to issue one or more (e.g., block) tickets to customers or recipients for one or more events (e.g., season tickets). In one implementation, for respective tickets, the ticket management computer system 41 provides a ticket identifier (e.g., serial number), and associates the ticket identifier with its location assignment for the event (or usage period). For additional privileges associated with the ticket (e.g., access to restricted areas in the event venue 1), the ticket management computer system 41 may also associate one or more privilege identifiers with the ticket identifier. Upon purchase, or other acquisition or assignment of the ticket, the ticket management system associates the ticket identifier with a first account identifier (e.g., name, alphanumeric code, etc.) of the customer or other recipient.

When performing the event access function, the ticket management system 40 authenticates tickets as they are scanned by the ticket scanning devices 20, so as to grant entry permissions ticketholders of valid tickets. The event access function may, for example, be implemented by ticket management computer system 41 that is in communication with the ticket scanning devices 20, which executes a ticket authentication program and stores various data.

Respective scanning devices 20 identify a ticket being scanned, generates packetized scan data identifying the scanned ticket (e.g., including the ticket identifier), and sends a signal (e.g., a ticket scan signal 72a) via the network 70 to the ticket management computer system 41, which contains the packetized scan data to communicate the identity of the scanned ticket (e.g., the ticket identifier). The scanning device 20 may, for example, observe and recognize a visual identifier, such as a quick response or QR code that is printed or displayed, to identify the ticket being scanned. The scanning device 20 may be a scanning system that includes a scanning computer system integrated with a scanning unit or located remotely to one or more peripheral scanning units 20 that are in wired or wireless communication with the scanning computer system.

The ticket management computer system 41 receives the ticket scan signal 72, processes the packetized scan data to identify the scanned ticket, and assesses whether the ticket scanned is valid. For example, the ticket management computer system 41 evaluates whether the event (or usage period) associated with the ticket identifier is proper and/or whether the ticket has been previously scanned.

After assessing the validity of the scanned ticket, the ticket management computer system 41 generates packetized data indicating whether the ticket is valid (e.g., packetized authentication data, indicating validity, wrong event/usage period, and/or previously scanned/used), and transmits the packetized authentication data via a ticket authentication signal 74a to the ticket scanning device 20. The ticket scanning device 20 receives and assesses the packetized authentication data to grant or deny entry of the ticketholder into the event venue 1. As an alternative to generating and sending packetized data, the ticket management computer system 41 and the other computer systems disclose herein may instead generate and/or send non-packetized data (e.g., bitstream data)

The ticket management system 40 is additionally configured to send and receive ticket information (e.g., first account identifier, ticket identifier, ticket usage, location assignment, and/or additional privileges) to/from the central system 60. For example, at periodic intervals (e.g., every five minutes and/or at recurring times), the central computer system 61 establishes an authenticated connection via the network 70 with the ticket management computer system 41 using a suitable authentication or security protocol. The authenticated connection may be established before and terminated after each instance or sequence of data transfer therebetween. The central computer system 61 then sends various signals and/or requests, which may contain various packetized data generated by the central computer system 61, to the ticket management computer system 41. In response, the ticket management computer system 41 processes the request or data received, executes various commands, and generates packetized data, which is transmitted back to the central computer system 61. For example, the central computer system 61 can receive data from the ticket management computer system 41 (e.g., from a computing device associated therewith), which data can reflect, for example, that a ticket holder is admitted access to the venue (e.g., that a valid ticket has been scanned). That data can be pushed from the ticket management computer system 41 or pulled by the central computer system 61. For example, the ticket management computer system 41 can transmit data reflecting that a ticket holder is admitted access to the venue upon a ticket of the ticket holder being scanned. In another example, the central computer system 61 can transmit a request for the data to, and responsively receive the data from, the ticket management computer system 41, for example, using a network interface of the central computer system 61. Further interaction between the ticket management system 40 and the central system 60 is discussed in further detail below.

The customer management system 50 receives, stores, and sends various information pertaining to the customers, and is implemented by and/or includes the customer management computer system 51. For example, for respective customers or prospective customers, the customer management computer system 51 stores and associates a second account identifier with customer information, including a customer name, customer photograph, status level, special events (e.g., birthdays, anniversaries, marital status), user entered information (e.g., engagement notes), etc. Thus, for respective customers, the ticket management system 40 uses (e.g., assigns, associates, etc.) the first account identifier, while the customer management system 50 uses (e.g., assigns/associates) the second account identifier that is different from the first account identifier. That is, the ticket managements 40 and the customer management system 50 use two different identifiers per customer.

The customer management system 50 may additionally associate respective customers with one or more users, such as a sales person, sales team member, and/or sales manager. Thus, the customer information may further include one or more user identifiers associated with the second account identifier, which are stored by the customer management computer system 51.

The customer management system 50 is additionally configured to send and receive customer information (e.g., the second account identifier, the user identifiers, and other customer information described previously) to/from the central system 60. For example, at periodic intervals (e.g., daily), the central computer system 61 establishes an authenticated connection via the network 70 with the customer management computer system 51 using a suitable authentication or security protocol. The authenticated connection may be established before and terminated after each instance or sequence of data transfer therebetween. The central computer system 61 then sends various signals and/or requests, which may contain various packetized data generated by the central computer system 61, to the customer management computer system 51. In response, the customer management computer system 51 processes the request or data received, executes various commands, and generates packetized data, which is transmitted back to the central computer system 61. For example, the central computer system 61 can receive data from the customer management computer system 51 (e.g., from a computing device associated therewith), which data can include, for example, information associated with a ticket holder who has been admitted access to a venue (e.g., based on a valid ticket having been scanned). That data can be pushed from the customer management computer system 51 or pulled by the central computer system 61. For example, the customer management computer system 51 can transmit data information associated with a ticket holder upon an indication that the ticket holder is admitted access to the venue. In another example, the central computer system 61 can transmit a request for the data to, and responsively receive the data from, the customer management computer system 51, for example, using a network interface of the central computer system 61. For example, the central computer system 61 can receive data from the ticket management computer system 41 indicating that a ticket of the ticket holder has been scanned and then transmit that received data to the customer management computer system 51 along with a request for the data including the information associated with the ticket holder. Further interaction between the customer management system 50 and the central system 60 is discussed in further detail below.

The customer management system 50 may additionally be configured to receive and store user-generated customer information from the central system 60, which is created by a user of one of the mobile electronic devices 30. As discussed in further detail below, upon entry of customer information by a user, the mobile electronic device 30 generates packetized data containing the user-generated customer information, and sends a signal containing the packetized user-generated customer information to the central computer system 61.

The central system 60 generates electronic records in real-time upon receipt of data from the ticket management system 40 and the customer management system 50. For example, the central system 60 may be configured, for respective customers, to associate the ticket information received from the ticket management system 40 and the customer information received from the customer management system 50. Associating the ticket information and the customer information may, for example, including combining a ticket identifier of the ticket information and an account identifier of the customer information. The central system 60 then distributes a generated electronic record to all or some of the mobile electronic devices 30₁₋ₙ in real-time upon generation of that electronic record. The central system 60 may additionally consolidate and transfer all or a subset of the ticket and customer consumer information received from the ticket management system 40 and the customer management system 50 to one or more of the mobile electronic devices 30 for storage and display thereon.

The central computer system 61 associates the first account identifier (e.g., the ticket identifier) from the ticket management computer system 41 and the second account identifier from the customer management computer system 51. For respective new customers, the central computer system 61 associates the first account identifier from the ticket management computer system 41 with the second account identifier from the customer management computer system 51. More particularly, and as discussed in further detail below, upon initiating a new customer with either the ticket management computer system 41 or the customer management computer system 51, the central computer system 61 requests the other of the ticket management computer system 41 or the customer management computer system 51 to create a new customer record or account for the new customer. Alternatively, the ticket management computer system 41 and/or the customer management computer system 51 may directly request that the other system create a new customer record or account.

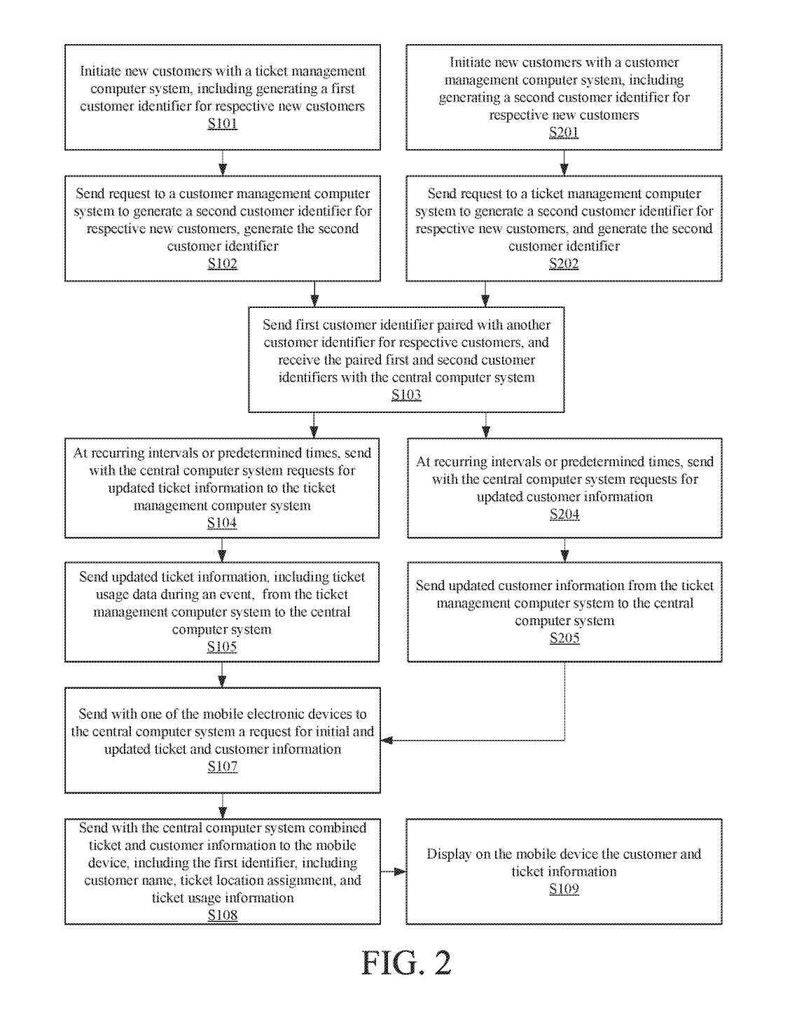

Referring to the flow chart in FIG. 2, in a step S101, a new customer may be initiated with the ticket management system 40 when a customer purchases tickets to the venue for a first time. The ticket management computer system 41 associates the customer with the first account identifier, such as by creating a new customer record or account and generating a new first account identifier associated with the new customer.

In subsequent steps, the customer management computer system 51 is caused to create a second account identifier for the new customer, which is also associated with the first account identifier for the new customer. In a step S102, the customer management computer system 51 receives a request to generate a second account identifier for the new customer (e.g., creating a customer record or account for the new customer), and then generates the second account identifier.

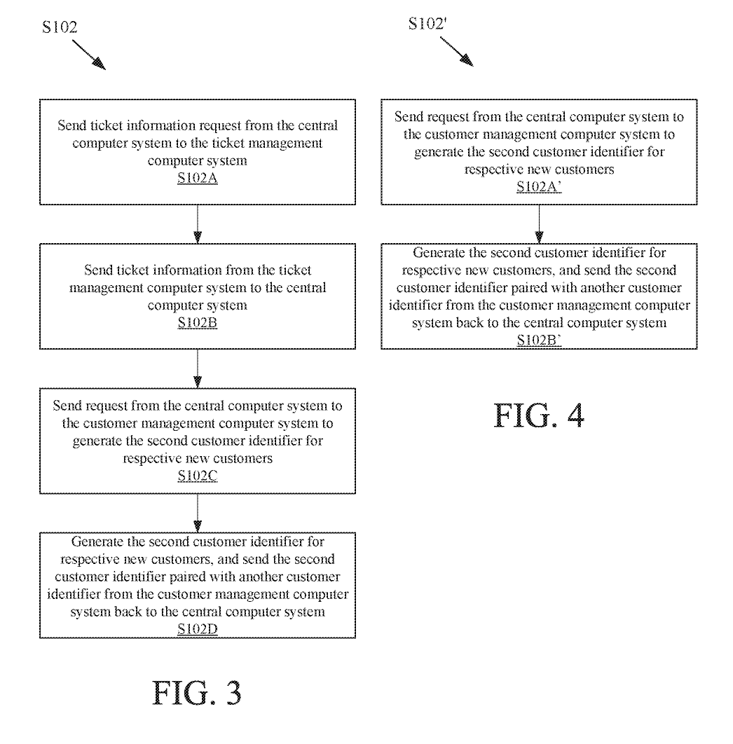

In one example, as shown in the flow chart in FIG. 3, step S102 includes a substep S102A in which the central computer system 61 sends a request signal 76a (e.g., ticket information request signal) to the ticket management computer system. The ticket information request signal may be sent periodically (e.g., at intervals, such as every five minutes, or at other predetermined times).

In a second substep S102B, upon receiving the ticket information request signal 76a, and after having already generated the new first account identifier, or upon an existing customer purchasing tickets to the venue 1 for the first time, the ticket management computer system 41 generates packetized data containing the first account identifier associated with the new customer to the central computer system 61, which is sent via a ticket information signal 74b. The ticket information signal 74b may contain additional packetized data regarding the new customer and tickets of other customers (e.g., customer name and other customer information, location assignment, usage information, privileges, and other ticketing information).

In a third substep S102C, after the central computer system 61 receives the ticket information signal 74b with the first account identifiers for new customers, the central computer system 61 sends a request signal 76b (e.g., customer account request signal) to the customer management computer system 51, which may contain information pertaining to respective new customers (e.g., first account identifier, customer name, address, etc.) originating from the ticket management computer system 41. The central computer system 61 may additionally create a third account identifier for respective new customers, which may be sent via the customer account request signal 76b to the customer management computer system 51.

In a fourth substep S102D, upon receiving the customer account request signal 76b, the customer management computer system 51 creates the new customer record or account for respective new customers, including generating a new second account identifier associated with such respective new customers. The customer management computer system 51 then sends back to the central computer system 61 the customer information signal 75a that contains, for respective new customers, the newly created second account identifier in a pairing or grouping with the first account identifier and/or the third account identifier.

As an alternative to the step S102, a step S102′ includes the ticket management computer system 41 communicating directly with the customer management computer system 61. In a first substep S102A′, the ticket management computer system 41 sends a request signal (e.g., customer account request signal) directly to the customer management computer system 51 after the first account identifier is created for respective new customers in the first step S101, or after an existing customer purchases a ticket to the event venue 1 for a first time.

In a second substep S102B′, the customer management computer system 51 responds by generating the second account identifier for respective new customers, and sends the second account identifier paired or grouped with the first account identifier and/or the third account identifier to the central computer system 61 directly or via the ticket management computer system 41.

Referring again to the flow chart in FIG. 2, another new customer may be initiated with the customer management system 50, for example, when the user enters information for a prospective customer for a first time into the customer management system 50. As described below, the process following initiating new customers with the customer management system 50 mirrors that described initiating new customers with the ticket management system 40.

In a step S201, the customer management computer system 51 associates respective new customers with a new second account identifier, such as by creating a new customer record or account and generating a new second account identifier associated with respective new customers.

In subsequent steps, the ticket management computer system 41 is caused to create a first account identifier for respective new customers, which are associated with the second account identifier for respective new customers. In a step S202, the ticket management computer system 41 receives a request to generate a first account identifier for the new customer (e.g., creating a customer record or account for the new customer), and then generates the first account identifier for the customer.

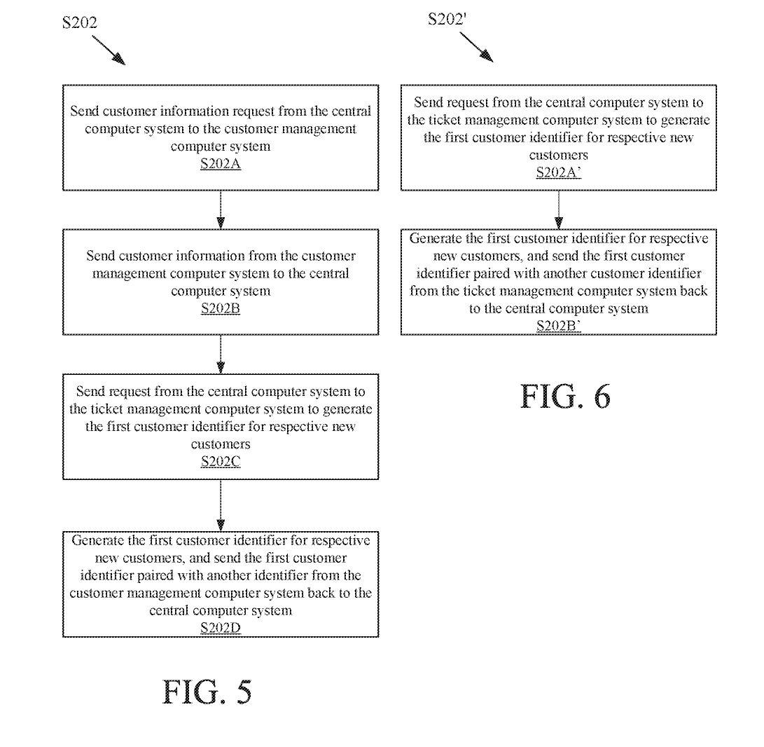

In one example, as shown in the flow chart in FIG. 5, step S202 includes a substep S202A in which the central computer system 61 sends a request signal 76c (e.g., customer information request signal) to the customer management computer system 51. The customer information request signal 76d may be sent periodically (e.g., at intervals, daily, or at other predetermined times).

In a second substep S202B, upon receiving the customer information request signal 76c, and after having already generated the new second account identifier, the customer management computer system 51 generates packetized data containing the second account identifier associated with respective new customers to the central computer system 61, and sends such information for a first time for the new customers via the customer information signal 75a. The customer information signal 75a may contain additional packetized data regarding other customers (e.g., new user generated information, etc.).

In a third substep S202C, after the central computer system 61 receives the customer information signal 75a with the second account identifiers for any new customers, the central computer system 61 sends a request signal 76d (e.g., ticket account request signal) to the ticket management computer system 41, which may contain information pertaining to respective new customers (e.g., second account identifier) originating from the customer management computer system 51. The central computer system 61 may additionally create a third account identifier for respective new customers, which may be sent via the ticket account request signal 76d to the ticket management computer system 51.

In a fourth substep S102D, upon receiving the ticket account request signal 76d, the ticket management computer system 41 creates the new customer record or account for respective new customers, including generating a new first account identifier associated with respective new customers. The ticket management computer system 41 then sends back to the central computer system 61 the ticket information signal 74b that contains, for respective new customers, the newly created first account identifier in a pairing or grouping with the second account identifier and/or the third account identifier.

As an alternative to the step S202, a second step S202′ includes the customer management computer system 51 communicating directly with the customer management computer system 61. In a first substep S202A′, the customer management computer system 51 sends a request signal (e.g., ticket account request signal) directly to the ticket management computer system 41 after the second account identifier is created for respective new customers in the first step S201.

In a second substep S202B′, the ticket management computer system 41 responds by generating the first account identifier for respective new customers, and sends the first account identifier paired with the second account identifier to central computer system 61 directly or via the customer management computer system 51.

In a step S103, the central computer system 61 receives the first account identifier paired or grouped with the second account identifier and/or the third account identifier. The pairing may be received by the central computer system 61 from either the ticket management computer system 41 (e.g., in the ticket information signal 74b) or from the customer management computer system 51 (e.g., in the customer information signal 75a).

By receiving the second account identifier paired with the first account identifier and/or the third account identifier, the central computer system 61 thereby associates the first account identifier with the second account identifier. And by associating the first account identifier with the second account identifier, the central computer system is able to associate further ticket information from the ticket management system 40 with further customer information from the customer management system 50.

During an event at the venue, the central system 60 is configured to provide to the user via the mobile electronic device 30 information pertaining to the customer and their ticket usage substantially in real time.

In a step S104, the central computer system 61 sends another ticket information request signal 76a to request further updated ticket information (e.g., ticket usage for the current event, and ticket information for new purchases). The ticket information request signal 76a may be sent at any desired interval or time as may be appropriate (e.g., at increased intervals prior to and during an event when ticket scans occur, and at decreased intervals after and between events when ticket scans do not occur). Note that the ticket information request signal 76a may be the same request used to retrieve information regarding new customers initiated with the ticket management computer system 41, or may be another or separate signal.

In a step S105, upon receiving the ticket information request signal 76a, the ticket management computer system 41 then generates packetized data with updated information containing the first account identifier and various ticket information for tickets associated with respective customers, then sends the packetized data via the ticket information signal 74b to the central computer system 61. The packetized data may, for example, contain only changed ticket information as compared to the information sent via the most recent ticket information signal 74b.

Similarly, in steps S204 and S205, the central computer system 61 sends recurring customer information request signals 76d at recurring intervals (e.g., daily), and the customer management computer system 51 generates packetized data with updated customer information, then sends the packetized data via the customer information signal 75a to the central computer system 61.

In a step S106, the central computer system 61 associates (e.g., stores) the ticket information received from the ticket management computer system 41 with the customer information received form the customer management computer system 51 based on the paired first and second account identifiers for respective customers. For respective customers, the central computer system 61 stores the first account identifier, the second account identifier, ticket information (e.g., location assignments, additional privileges, real-time usage, and/or historical usage), and customer information (e.g., name, customer photograph, status level, special events, and/or user entered information) in suitable databases.

The central system 60 provides the customer information for respective customers to the plurality of mobile electronic devices 30 substantially in real-time with scanning the tickets by the scanning devices 20.

Respective mobile electronic devices 30 (e.g., smartphone, tablet computer, etc.) is configured with a memory, a processor, and a wireless communication interface, as recognized by those skilled in the art. A program stored by the memory and executed by the processor facilitates the transfer of information between the central computer system 61 and causes display of certain information to the user, as will be discussed in further detail below.

In a step S107, the mobile electronic device 30 sends request signals 73a (e.g., combined information request) to the central computer system 61. The mobile electronic device 30 sends the combined information request signal 73a at various times, including upon the program being executed for a first time, as well as at subsequent predefined intervals and/or upon the user initiating the combined information request signal 73a. The predefined intervals may vary in time, such as by increasing in frequency just prior to and during an event, while decreasing in frequency after and between events. Furthermore, the information request signal 73a may also identify the particular mobile electronic device 30 (e.g., by its user or user identifier).

In a step S108, upon receiving the combined information request 73a from the mobile electronic device 30, the central computer system 61 generates packetized data (e.g., combined information), and sends the packetized data via a combined data signal 76f back to the mobile electronic device 30. The combined data signal 76f may contain an electronic record including, for example, ticket information and customer information associated only with customers associated with the user of the mobile electronic device 30.

A first combined data signal 76f sent to the mobile electronic device 30 may contain an electronic record including, for example, ticket information and customer information (e.g., customer name, ticket location assignment, ticket usage information, among other information discussed below) for all customers associated with the user. This initial information is stored by the mobile electronic device 30. Subsequent combined data signals 76e include changed information (e.g., as tickets are scanned or purchased). Such information may be stored and accumulated over a course of events (e.g., a sports season) or may be stored for a particular event (e.g., a concert or sports game). With the central computer system 61 receiving ticket information from the ticket management computer system 41 at recurring intervals, and central computer system 61 sending the ticket information to the mobile electronic device 30 upon user request or at predetermined intervals, the mobile electronic device 30 receives ticket information substantially in real time (e.g., as tickets are scanned, or within intervals thereof).

In a step S109, the mobile electronic device 30 then displays the electronic record (including, for example, the customer information and ticket information associated therewith), as discussed in further detail below. For example, in the S108, a determination can be made to transmit the electronic record to some of the mobile electronic devices 30₁₋ₙ based on an association between the ticket holder associated with a scanned ticket and one or more users of the mobile electronic devices 30₁₋ₙ. For example, those users may be employees or like representatives of the venue to which the ticket holder is admitted access, which users are assigned to service the ticket holder, for example, based on the ticket location assignment associated with the ticket identifier or the account identifier associated with the ticket holder.

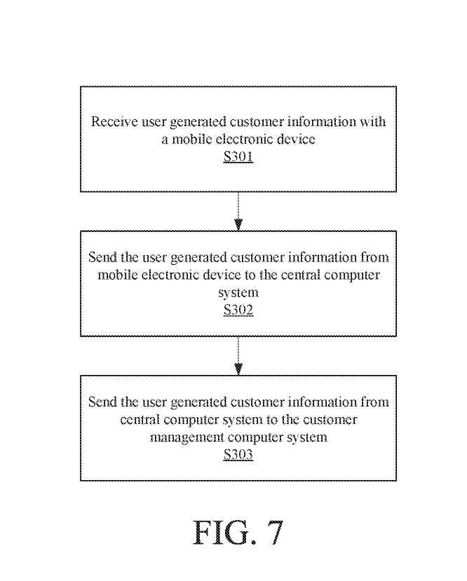

The mobile electronic device 30 is also configured to send user generated information to the central computer system 61, which is ultimately sent to the customer management computer system 51 in a method used in conjunction with the method shown in FIG. 2. As shown in FIG. 7, in step S301, the mobile electronic device 30 receives the user generated information entered by the user to the mobile electronic device 30. In step S302, the mobile electronic device 30 generates packetized data (e.g., packetized user generated information), and sends such packetized data to the central computer system 61 via a data signal 73b (e.g., a user generated data signal), which may, for example, be sent in conjunction with the combined information request signal 73a. In step S303, the central computer system 61 then sends the packetized data, or generates and sends new packetized data, to the customer management computer system 51 in another data signal 76f (e.g., a forwarding user generated data signal), which is then stored by the customer management computer system 51.

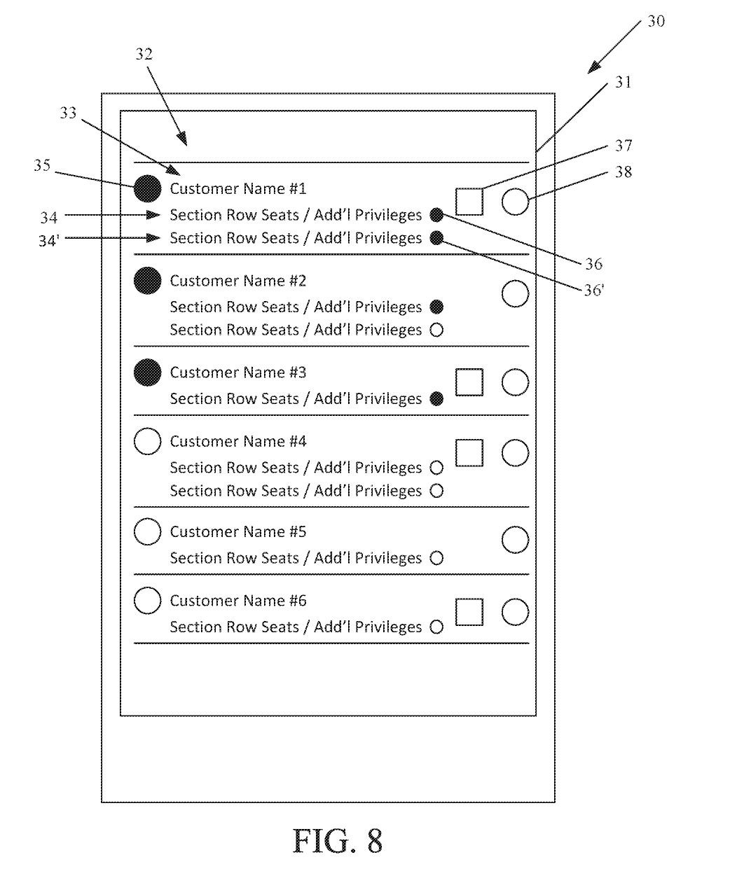

The mobile electronic device 30 displays various of the ticket information and the customer information in a consolidated manner in real time. As shown in FIG. 8, the mobile electronic device 30 includes a graphical user interface 31 (e.g., an LCD or other electronic display) or other type of electronic display, which displays a customer list 32 of the customers that are associated with the particular user. For respective customers, the customer list 32 includes a customer name 33, a location indicator 34, 34′ for respective ticket blocks associated with the customer, a first usage alert or indicator 35 (e.g., customer usage alert), and a second usage alert or indicator 36, 36′ for respective ticket blocks associated with the customer. The location indicator 34 provides information identifying the location assignment associated with the tickets in the block, and may also identify additional privileges that are associated with the tickets in the block. The location indicator 34 additionally displays the location information for the tickets of a block in a consolidated manner, as opposed to for tickets individually.

The first usage alert 35 is a binary indicator (e.g., on or off) that indicates whether at least one ticket associated with the customer has been scanned (e.g., the first scanned ticket in any block of tickets associated with the customer). The first usage alert 35 is activated (e.g., appears, fills, changes shading, changes color, etc.) when at least one ticket associated with the customer is scanned, and thereafter remains in such state for a duration of the event, or other time period as may be desirable (e.g., a period of time after the event concludes). The second usage alert 36 is also a binary indicator (e.g., on or off) that indicates whether at least one ticket of a particular ticket block associated with the customer has been scanned (e.g., the first scanned ticket of that particular block of tickets).

The customer list 32 may additionally display for respective customers an event indicator 37 and/or a contact indicator 38. The event indicator 37 indicates to the user that a special event of the customer (e.g., birthday, anniversary, etc.) is occurring on the present day. The contact indicator 38 indicates that contact information associated with the customer is available. By pressing the contact indicator 38, the mobile electronic device 30 may be prompted to make a telephone call, or send a message (e.g., SMS, email, or other text-containing message) to a device of the customer.

The customer list 32 may be sortable and/or filterable by the user. For example, the customer names 33 of all customers associated with the user may be displayed in alphabetical order by default, but may be filterable and/or sortable by the first usage alert 35 (e.g., to display or prioritize those customers for which a ticket associated therewith has been scanned), the location indicators 34, 34′ (e.g., to display only those customers having tickets with location assignments in a particular area of the event venue 1, or a particular privilege), event indicator 37 (e.g., those having a birthday or anniversary), and/or search (e.g., a portion of a customer name).

The customer lists 32 of certain users may additionally include customer lists that are associated with other users. For example, the customer list 32 of a sales manager may include those customers that are associated with salespersons that report to the sales manager. The customer list 32 of the sales manager may additionally be filterable by salesperson, so as to list those customer names 33 of customers associated with a particular sales person.

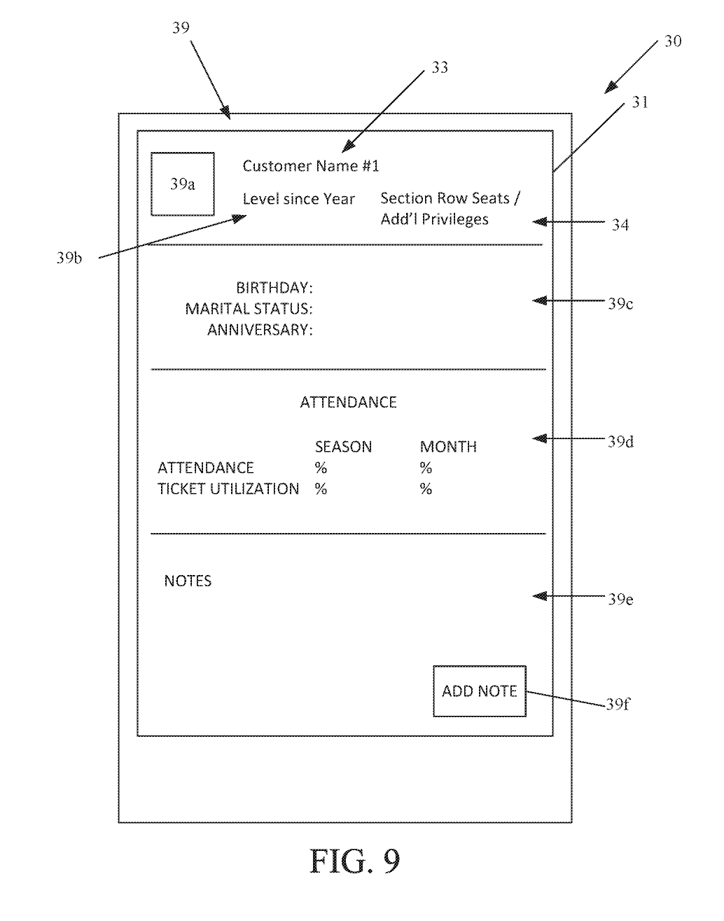

Respective customer names 33 may be selectable form the customer list 32, which causes the display 31 to display a customer profile page 39, as shown in FIG. 9. The customer profile page 39 includes customer information that, for example, includes the customer name 33, customer photograph 39a, customer level 39b (e.g., season ticket holder since), ticket location information 34 (e.g., section, seat, row, and privileges for respective ticket blocks), special event information 39c (e.g., birthday, marital status, anniversary, etc.), attendance statistics 39d (e.g., attendance and ticket utilization by month and by season), and/or customizable information 39e (e.g., engagement notes). The customer profile page 39 may additionally provide an icon 39f that when pressed prompts a user to enter additional customizable information.

While this disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system for real-time distribution of electronic records generated based on data received from a plurality of sources, the system comprising:
a centralized computing device including a memory and a processor, wherein the plurality of sources are external to the centralized computing device, wherein the processor is configured to execute instructions stored in the memory to:
receive first data from a first source of the plurality of sources, the first data reflecting that a ticket holder is admitted access to a venue;
receive second data from a second source of the plurality of sources, the second data including information associated with the ticket holder;
generate an electronic record in real-time upon receipt of the first data and the second data, the electronic record indicating the first data and the second data; and
distribute the electronic record to a plurality of mobile electronic devices in real-time upon generation of the electronic record, the plurality of mobile electronic devices located at the venue.

2. The system of claim 1, wherein the first source is a computing device associated with a ticket management computer system, wherein the second source is a computing device associated with a customer management computer system, wherein the first data includes a ticket identifier associated with a ticket used to admit access to the venue for the ticket holder, wherein the second data includes an account identifier associated with the ticket holder.

3. The system of claim 2, wherein the instructions to receive the first data from the first source of the plurality of sources include instructions to:
transmit, using a network interface of the centralized computing device, a request for the ticket identifier to the computing device associated with the ticket management computer system; and
receive, using the network interface, the ticket identifier from the computing device associated with the ticket management computer system responsive to the request.

4. The system of claim 2, wherein the instructions to receive the second data from the second source of the plurality of sources include instructions to:
transmit, using a network interface of the centralized computing device, a request for the account identifier to the computing device associated with the customer management computer system, the request including an indication of the ticket identifier; and
receive, using the network interface, the account identifier from the computing device associated with the customer management computer system responsive to the request.

5. The system of claim 2, wherein the instructions to distribute the electronic record to the plurality of mobile electronic devices in real-time upon the generation of the electronic record include instructions to:
determine to transmit the electronic record to at least some mobile electronic devices of the plurality of mobile electronic devices based on an association between the ticket holder and one or more users of the at least some mobile electronic devices; and
transmit the electronic record to the at least some mobile electronic devices to cause the at least some mobile electronic devices to display the electronic record.

6. The system of claim 5, wherein the instructions to cause the at least some mobile electronic devices to display the electronic record include instructions to:
change a value of a binary indicator to reflect that the ticket has been used to admit access to the venue for the ticket holder.

7. The system of claim 5, wherein the electronic record reflects at least one of a serial number associated with the ticket identifier, a ticket location assignment associated with the ticket identifier, a privilege associated with the ticket identifier, ticket usage information associated with the ticket identifier, a customer name associated with the account identifier, an address associated with the account identifier, an alphanumeric code associated with the account identifier, a customer photograph associated with the account identifier, a status level associated with the account identifier, a special event indication associated with the account identifier, user entered information associated with the account identifier, or attendance statistics associated with the account identifier.

8. A method for real-time distribution of electronic records generated based on data received from a plurality of external sources, the method comprising:
receiving first data from a first external source of the plurality of external sources, the first data reflecting that a ticket holder is admitted access to a venue;
receiving second data from a second external source of the plurality of external sources, the second data including information associated with the ticket holder;
generating an electronic record in real-time upon receipt of the first data and the second data, the electronic record indicating the first data and the second data; and
distributing the electronic record to a plurality of mobile electronic devices in real-time upon generation of the electronic record, the plurality of mobile electronic devices located at the venue.

9. The method of claim 8, wherein receiving the first data from the first external source of the plurality of external sources comprises:
transmitting a request for the first data to a computing device associated with the first external source, wherein the first data is received responsive to the request.

10. The method of claim 8, wherein receiving the second data from the second external source of the plurality of external sources comprises:
transmitting a request for the second data to a computing device associated with the second external source, wherein the request indicates at least a portion of the first data, wherein the second data is received responsive to the request.

11. The method of claim 8, wherein the first data includes a ticket identifier associated with a ticket used to admit access to the venue for the ticket holder, wherein the second data includes an account identifier associated with the ticket holder.

12. The method of claim 11, wherein generating the electronic record in real-time upon receipt of the first data and the second data comprises:
combining the ticket identifier and the account identifier.

13. The method of claim 11, wherein distributing the electronic record to the plurality of mobile electronic devices in real-time upon the generation of the electronic record comprises:
determining to transmit the electronic record to at least some mobile electronic devices of the plurality of mobile electronic devices based on an association between the ticket holder and one or more users of the at least some mobile electronic devices; and
transmitting the electronic record to the at least some mobile electronic devices to cause the at least some mobile electronic devices to display the electronic record.

14. The method of claim 11, wherein the electronic record reflects at least one of a serial number associated with the ticket identifier, a ticket location assignment associated with the ticket identifier, a privilege associated with the ticket identifier, ticket usage information associated with the ticket identifier, a customer name associated with the account identifier, an address associated with the account identifier, an alphanumeric code associated with the account identifier, a customer photograph associated with the account identifier, a status level associated with the account identifier, a special event indication associated with the account identifier, user entered information associated with the account identifier, or attendance statistics associated with the account identifier.

15. The method of claim 8, further comprising:
receiving instructions to update the second data from at least one mobile electronic device of the plurality of mobile electronic devices; and
transmitting, to a computing device associated with the second external source, a request to update the second data according to the instructions.

16. The method of claim 8, further comprising:
receiving an update to the first data from a computing device associated with the first external source;
updating the electronic record according to the update to the first data; and
subsequent to the updating, redistributing the electronic record to the plurality of mobile electronic devices.

17. The method of claim 8, further comprising:
receiving, from at least one mobile electronic device of the plurality of mobile electronic devices, a request for an updated electronic record;
responsive to the request, determining that at least one of the first data or the second data changed subsequent to the generation of the electronic record;
responsive to the determining, updating the electronic record according to a change to the at least one of the first data or the second data; and
subsequent to the updating, redistributing the electronic record to the at least one mobile electronic device.

18. The method of claim 8, further comprising:
prior to receiving the first data, transmitting, for display by at least one mobile electronic device of the plurality of mobile electronic devices, a first value of a binary indicator reflecting that a ticket has not been used to admit access to the venue for the ticket holder; and
responsive to distributing the electronic record to the plurality of mobile electronic devices, causing the first value of the binary indicator to change to a second value reflecting that the ticket has been used to admit access to the venue for the ticket holder.

19. A non-transitory computer-readable storage medium, comprising processor-executable routines that, when executed by a processor, facilitate a performance of operations comprising:
generating an electronic record in real-time upon receipt of first data and second data, the first data received from a computing device associated with a ticket management computer system and including a ticket identifier associated with a ticket used to admit access to a venue for a ticket holder, the second data received from a computing device associated with a customer management computer system and including an account identifier associated with the ticket holder; and
distributing the electronic record to a plurality of mobile electronic devices in real-time upon generation of the electronic record, the plurality of mobile electronic devices located at the venue, wherein the distributing causes the plurality of mobile electronic devices to display the record, wherein the distributing further causes a value of a binary indicator to change in order to reflect that the ticket has been used to admit access to the venue for the ticket holder.

20. The non-transitory computer-readable storage medium of claim 19, wherein the electronic record reflects at least one of a serial number associated with the ticket identifier, a ticket location assignment associated with the ticket identifier, a privilege associated with the ticket identifier, ticket usage information associated with the ticket identifier, a customer name associated with the account identifier, an address associated with the account identifier, an alphanumeric code associated with the account identifier, a customer photograph associated with the account identifier, a status level associated with the account identifier, a special event indication associated with the account identifier, user entered information associated with the account identifier, or attendance statistics associated with the account identifier.
